(19) United States
(12) Patent Application Publication
(10) Pub. No.: US 2003/0064902 A1
(43) Pub. Date: Apr. 3, 2003

(54) Apparatus and process for producing polished semiconductor wafers

(75) Inventors: Kan-Yin Ng, St. Louis, MO (US); James Jose, Wentzville, MO (US); Stephen Hensiek, Foley, MO (US); Peter Albrecht, O'Fallon, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: MEMC Electronic Materials Inc.

(21) Appl. No.: 09/970,404

(22) Filed: Oct. 3, 2001

(51) Int. Cl. C11D 1/00

(52) U.S. Cl. 510/175

(57) ABSTRACT

A process for forming a semiconductor wafer which is single side polished improves nanotopography and flatness of the polished wafer. The process reduces the effect of back side surface features, such as edge ring phenomena and back side laser marks, on nanotopography and local site flatness, thereby improving oxide layer uniformity for chemical/mechanical planarization (CMP) processing, and flatness on the polished front side of the wafer after polishing. The wafer is mounted on a polishing block by wax so as to minimize transfer of imperfections in the wax to the front side of the wafer. In particular, the wafer is retained in a centered position on the polishing block. Moreover, the wafer is mounted at atmospheric pressure while still removing air bubbles from the wax.

### BACKGROUND OF THE INVENTION

This invention relates generally to polishing semiconductor wafers and more particularly to single side polishing semiconductor wafers to improve nanotopography and local site flatness so as to minimize thickness variations in a thin dielectric layer thickness.

The continued drive for miniaturization of electronic devices printed on semiconductor substrates places increasing technical demands on device manufacturers, and also suppliers of semiconductor wafers on which the devices are imprinted. Miniaturization is reaching the stage where circuit line widths are decreased beyond present levels, into ranges below 0.13 microns. It is well documented that decreasing the line width decreases the amount of acceptable deviations of the surface of the wafer from being perfectly flat. Semiconductor wafers, including any layers deposited on the surface of the wafer, must be particularly flat in order to print circuits on them by, for example, an electron beam-lithographic or a photolithographic process. Wafer flatness in the focal point of the electron beam delineator or optical printer is important for uniform imaging in the electron beam-lithographic and photolithographic processes. The flatness of the wafer surface directly impacts device line width capability, process latitude, yield and throughput. The depth of focus of the electron beam delineator or optical printer limits the amount of local elevational variation in the wafer surface topography which is permitted.

However it has not been as well documented, until recently, that as line widths are reduced additional problems arise related to the topography of a single (front) surface of the wafer. Devices are built up on the semiconductor substrate in numerous (e.g., 10 to 20) layers. As the line widths decrease, they become relatively tall in relation to their width. This makes it difficult to keep the built up line generally perpendicular to the wafer surface. To reduce this effect, layers are being applied with a lesser thickness. In particular, the insulating oxide (dielectric) layer has been significantly reduced in thickness. Another change to device manufacture is that it has become necessary to use chemical/mechanical planarization (CMP) on the front surface of the wafer between application of certain layers in order to maintain flatness. However, CMP decreases the thickness of the layer applied prior to CMP. Features on the surface of the wafer to which the oxide layer is applied can give rise to discontinuities in dielectric layer thickness. Where the layers are particularly thin, polishing can reduce the thickness to the point where current leakage occurs, causing failure of that part of the wafer and concomitant loss of yield.

Differences in surface elevation in the range of just 100 nanometers can cause problems with oxide layer thickness during device manufacture. One source of these discontinuities is the edge ring phenomena. Etching processes cause peripheral rings on the front and back surfaces of the wafer to form. Conventional single side polishing is not capable of removing these edge rings. The wafer is held flat during polishing, effectively tending to flatten out the edge ring. However, when the wafer is released after polishing, the edge ring feature reappears. The thickness of the oxide layer is reduced when CMP is performed on the layer. Because of the oxide layer is particularly thin, even a slight discontinuity in the front surface of the wafer can cause the oxide layer to be so thin after CMP that current leakage occurs and that area of the wafer fails.

In order to identify and address these problems, device and semiconductor material manufacturers are now considering the nanotopography of the front face of the wafer. Nanotopography has been defined as the deviation of a wafer surface within a spatial wavelength of about 1 mm to 20 mm. This spatial wavelength corresponds very closely to surface features on the nanometer scale for processed semiconductor wafers. The foregoing definition has been proposed by Semiconductor Equipment and Materials International (SEMI), a global trade association for the semiconductor industry (SEMI document 3089). Nanotopography measures on the elevational deviations of one surface of the wafer and does not consider thickness variations of the wafer, as with traditional flatness measurements. Edge rings are one of the features which most profoundly affect nanotopography, including particular oxide layer uniformity in the CMP process (see, K. V. Ravi, “Wafer Flatness Requirements for Future Technology”, Future Fab International, July, 1999). Several metrology methods have been developed to detect and record these kinds of surface variations. For instance, the measurement deviation of reflected light from incidence light allows detection of very small surface variations. These methods are used to measure peak to valley (PV) variations within the wavelength 1 mm to 20 mm.

Etching is not the only source for producing undesired surface features. Wafer producers often use identification marks on the silicon wafers to track them through the various wafering processes. In this manner, different marks can be used to indicate different wafer characteristics, identify the source of defective wafers or otherwise trace the origin of a particular wafer or lot of wafers. For example, a series of laser-scribed dots (also referred to as hard marking) may be used to form an identification number on a surface of a wafer. Lumonics sells a number of suitable dot matrix machines under the trademark WaferMark® for hard marking identification marks on silicon wafers with a laser. In certain conditions, laser marks on the back surfaces of wafers tend to leave corresponding bumps on the front sides of the wafers after polishing. Laser mark bumps tend to occur when the wafers are wax mounted in vacuum pressure. The cavities on the back side of the wafer are drawn to a vacuum pressure which tends to deflect the wafer and also draws wax into the laser mark hole. The ultimate effect is that bumps are found on the polished side of the wafer after polishing is completed. These bumps can affect oxide layer thickness when the oxide layers are subjected to CMP. The bumps can be described as a nanotopography defect, but are also usually large enough to be measured as a “local flatness” feature, commonly called “local site flatness”.

Another common source of surface features on a polished wafer arises in the mounting of wafers on polishing blocks in preparation for polishing. Wax is used to adhere back surfaces of the wafers to the polishing blocks. To avoid producing surface features on the polished front face, it is necessary that the wax layer between the wafer and the block be extremely uniform in thickness. A well known source of non-uniformity are air bubbles in the wax after the wafer is mounted on the polishing block. One conventional treatment is disclosed in U.S. Pat. No. 4,316,757 in which wafers are wax-mounted on a polishing plate in a low pressure environment to facilitate drawing air out of the wax upon mounting of the wafers. This approach has worked well, but requires special, low pressure equipment and reduces throughput. A further solution is shown in European Application Publication No. 0 868 977. The European application shows to bend the wafer so that the center of the wafer touches the wax first. An inflatable bladder presses the wafer into the wax on the polishing block (or plate) so that the wafer is applied to the wax from its center toward its peripheral edges. In this way air bubbles are pushed out of the wax by the wafer. A special jig is needed to deflect the wafer for application to the wax layer. Preferably, the wafer should be deflected no more than necessary.

Another problem which may arise occurs in single wafer polishing, in which each wafer is mounted on its own polishing block. If the wafer is mounted off-center on the polishing block, the force subsequently applied by the polisher is spaced from the center of the wafer. As a result, the wafer has a tapered shape after polishing. In other words, the wafer grows thicker moving from point on the edge to a diametrically opposite point.

### SUMMARY OF THE INVENTION

Among the several objects and features of the present invention may be noted the provision of apparatus and a process of forming semiconductor wafers which have a high degree of flatness; the provision of such apparatus and a process which form semiconductor wafers with superior nanotopography; the provision of such apparatus and a process which reduces the occurrence of taper in a polished wafer; the provision of such apparatus and a process which increase the throughput of polished wafers; the provision of such apparatus and a process which reduce the number of steps required to wax-mount a wafer on a polishing block or plate; the provision of such apparatus and a process which reduce variations in the thickness of a dielectric material on the one side of the wafer; the provision of such apparatus and a process which facilitate the imprinting of extremely narrow width lines for manufacturing smaller IC devices on the wafer; the provision of such apparatus and a process which reduces dielectric layer non-uniformity caused by formation of an edge ring on the wafer during prior processing of the wafer; the provision of such apparatus and a process which reduces degradation in flatness and dielectric layer uniformity caused by laser marks on the back side of the wafer.

In one aspect of the present invention, a process of forming a semiconductor wafer which inhibits the formation of surface features on a polished front side of the wafer generally comprises the step of slicing a wafer from an ingot of semiconductor material. Damage is removed from at least one side of the wafer, and a layer of wax is formed on a mounting surface of the polishing block. The semiconductor wafer is mounted on the mounting surface of the polishing block by first holding the wafer in an undeflected position and dropping the undeflected wafer so that a backside of the wafer contacts the layer of wax. A bladder is inflated to press the wafer into the wax and remove air from between the wafer and the polishing block in the wax. The front side of the wafer as mounted on the polishing block is polished by holding the polishing block and rubbing the front side of the wafer against a polishing pad in the presence of a polishing slurry. The polished wafer is removed from the polishing block and cleaned

In another aspect of the present invention apparatus for wax mounting a semiconductor wafer on a polishing block in preparation for polishing a front side of the wafer, the apparatus generally comprises a platform for holding the polishing block with a mounting surface of the polishing block having a layer of wax thereon facing upward. A wafer centering device is movable relative to the platform between closed and open positions. In the closed position, the wafer centering device is disposed relative to the platform for engagement with the wafer to center the wafer on the mounting surface of the polishing block. A wafer pressing mechanism engageable with the front face of the wafer presses the wafer into the wax on the mounting surface of the polishing block.

Other objects and features of the present invention will be in part apparent and in part pointed out hereinafter.

### BRIEF DESCRIPTION OF THE DRAWINGS

FIG. 1 is schematic illustration of apparatus of the present invention for wax-mounting a semiconductor wafer on a polishing block;

FIG. 2 is a perspective of a wafer centering device of the apparatus;

FIG. 3 is a top plan view of the wafer centering device;

FIG. 4 is a fragmentary section taken in the plane including line 4-4 of FIG. 3;

FIG. 5 is a fragmentary section taken in the plane including line 5-5 of FIG. 3;

FIG. 6 is an enlarged side elevation of a locator pin of the wafer centering device;

FIGS. 7A-7D are schematic illustrations showing a sequence of operation of the apparatus;

FIG. 8A is an image showing surface features of a polished wafer mounted by a cold wax mounting process;

FIG. 8B is an image showing surface features of a polished wafer mounted by a low pressure wax mounting process; and

FIG. 8C is an image showing surface features of a polished wafer mounted by the apparatus and process of the present invention.

Corresponding reference characters indicate corresponding parts throughout the several views of the drawings.

### DETAILED DESCRIPTION OF THE PREFERRED EMBODIMENTS

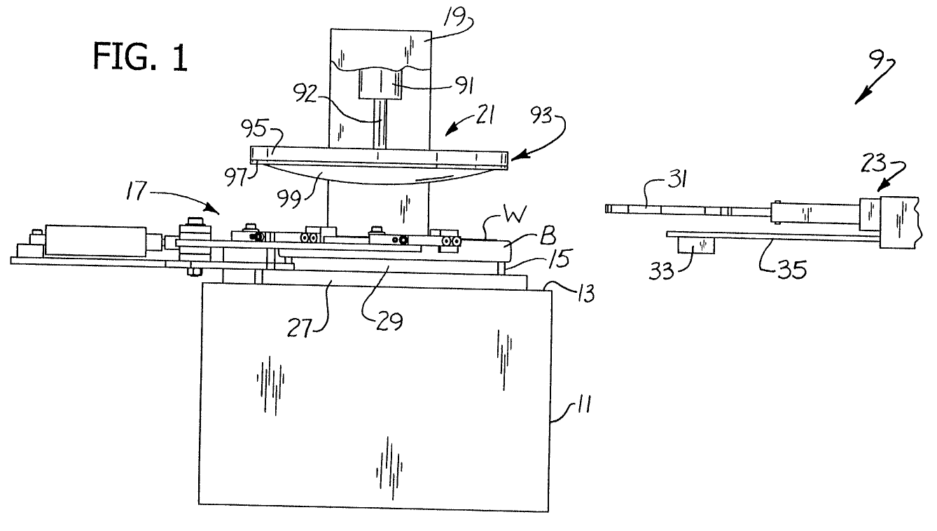

Referring now to the drawings and in particular to FIG. 1, apparatus of the present invention (generally indicated at 9) is shown to comprise a table 11 having a top 13, a platform 15 on the table for supporting a polishing block B on which a semiconductor wafer W is to be mounted and a wafer centering device (generally indicated at 17) for centering the wafer on the polishing block. A frame 19 supports a wafer pressing mechanism, generally indicated at 21, above the platform 15 for pressing the wafer W against a wax layer (not shown) formed on the polishing block B. A robot for handling the wafer indicated generally at 23 is generally similar to the robot disclosed in co-assigned U.S. Pat. No. 5,605,487, the disclosure of which is incorporated herein by reference. The apparatus 9 of the present invention may also be used in an automated polishing machine such as shown in U.S. Pat. No. 5,605,487. The robot 23 is able to pivot about both horizontal and vertical axes, and also to extend and retract in both horizontal and vertical directions. The robot 23 is capable of automatically handling the wafer W, the polishing block B and the wafer/block unit U. Any suitable manner or a device for handling the wafers and polishing blocks would be appropriate with the apparatus 9 of the present invention. Although the preferred embodiment is described as applied to single wafer polishing, the principles of the present invention are also applicable to batch polishing of wafers.

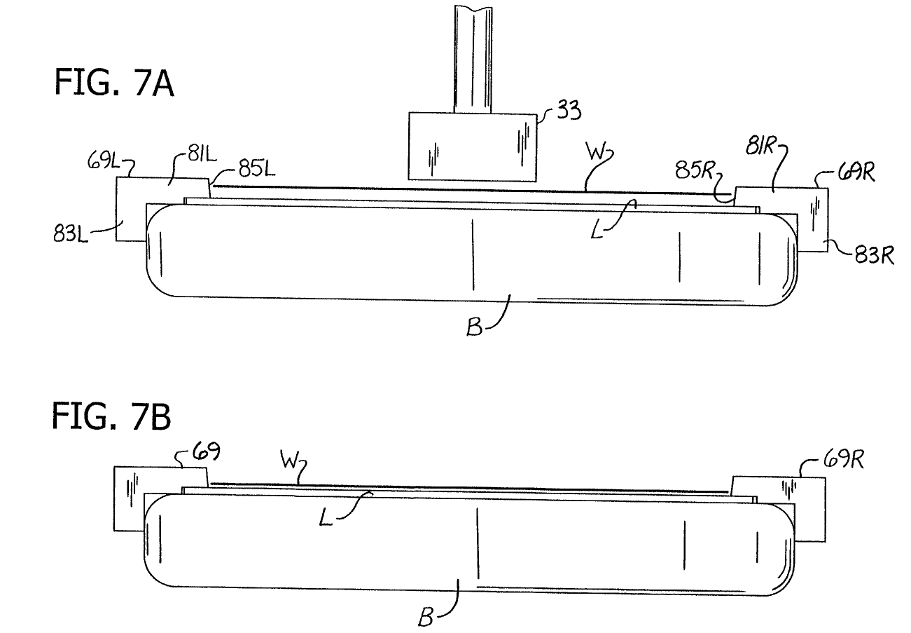

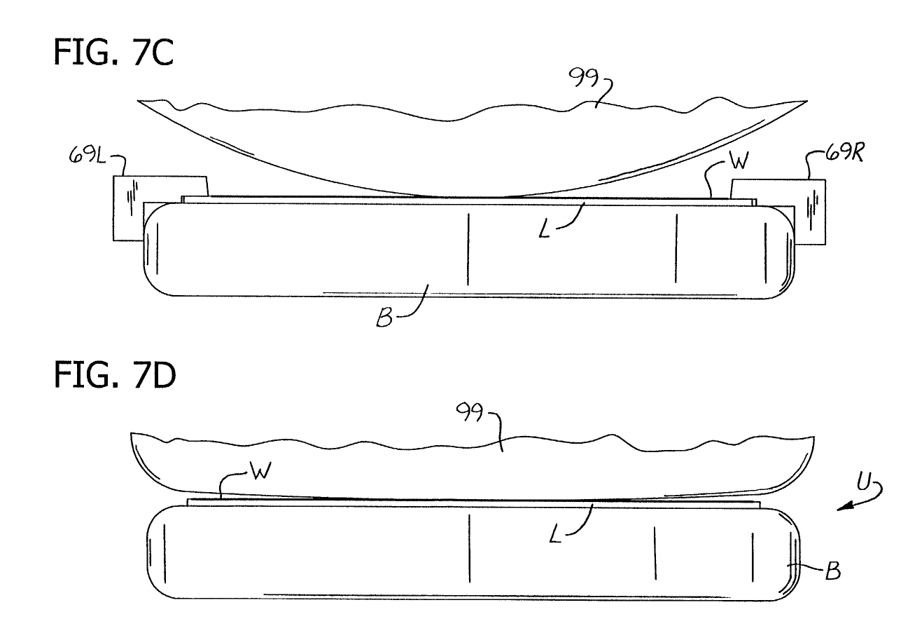

The platform 15 includes a mounting flange 27 attached to the table 11 and a steam pot 29 on which the polishing block B rests. In the illustrated embodiment, the portion of the platform 15 which supports the polishing block B is the upper surface of the steam pot 29 which heats the polishing block to maintain the wax on an upwardly facing mounting surface of the polishing block in a soft, flowable state. However, it is to be understood that other types of heating devices, such as an electric heating plate or infrared heaters (not shown) could be employed without departing from the scope of the present invention. Prior to its placement in on the platform 15, the polishing block B would have a layer of wax L (see FIGS. 7A-7D) applied to it at a wax application station (not shown). The robot 23 includes a pair of pinchers 31 (only one is shown) and a separate vacuum gripper 33. The pinchers 31 are used to capture the polishing block B for placement of the polishing block (having the layer of wax L thereon) on the platform 15 and for removal of the polishing block and wafer unit U. The vacuum gripper 33 is used to grip the wafer W by itself, with the wafer located in a horizontal orientation below the vacuum gripper. An arm 35 of the robot 23 may extend to place the wafer W over the polishing block B, the robot may lower the arm so that the wafer is spaced closely (e.g., about 0.5 mm) above the layer of wax L on the polishing block. The vacuum gripper 33 applies a slight positive pressure to the wafer to release the wafer, allowing it to fall a short distance onto the wax. Free fall of the wafer W onto the wax helps to prevent disturbing the uniform thickness of the wax layer L which could occur if the robot 23 applies even the slightest pressure forcing the wafer into the wax layer.

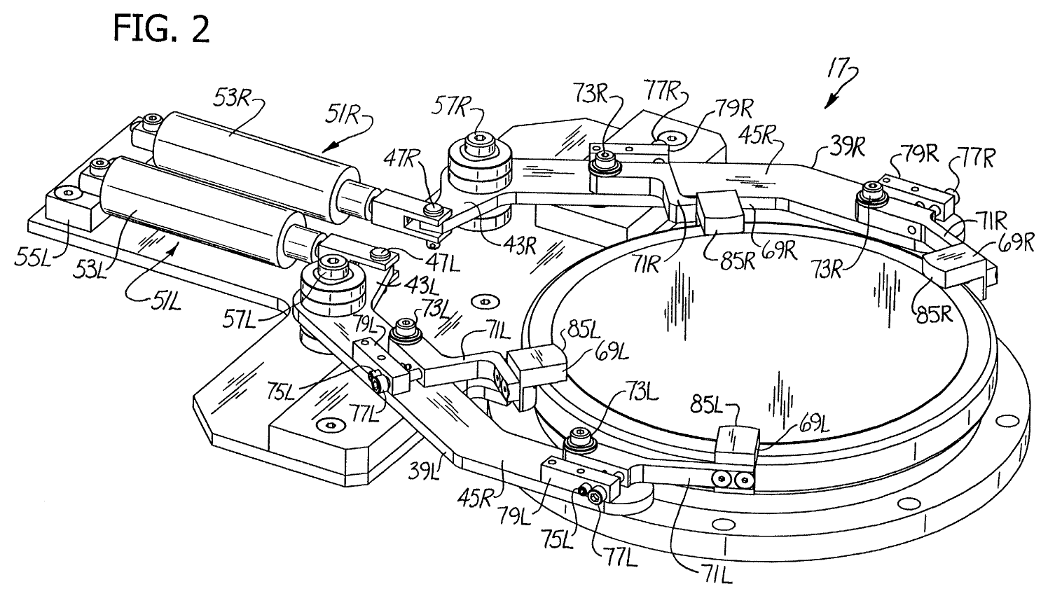

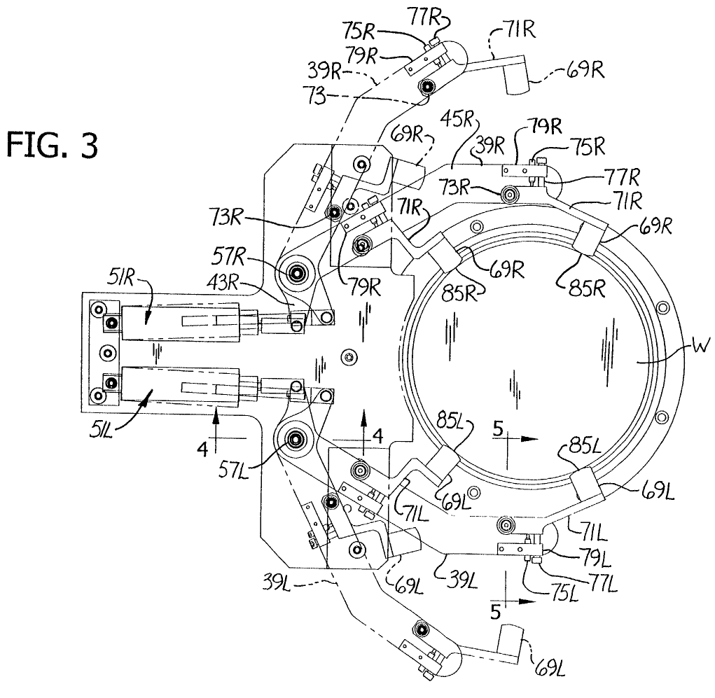

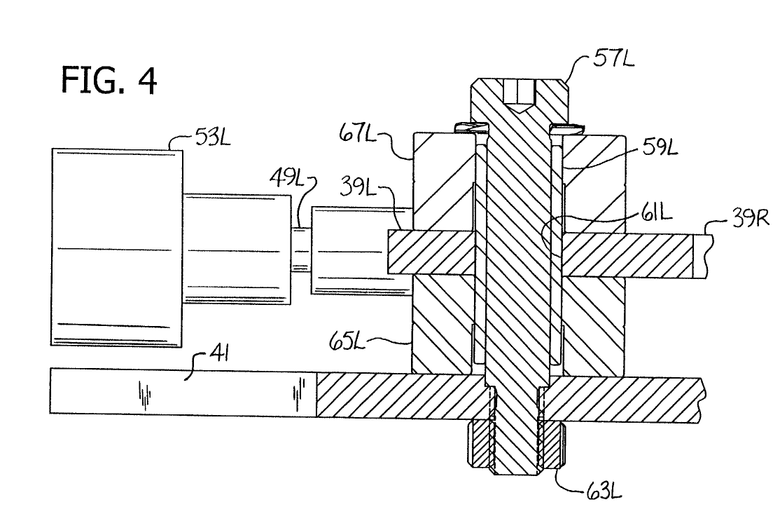

The wafer centering device 17 centers the wafer W on the polishing block B and prevents it from moving horizontally as it is placed on the polishing block. Referring now to FIGS. 2 and 3 it may be seen that the wafer centering device 17 comprises a pair of arms 39L, 39R pivotally mounted on a base 41 attached by bolts to the table 11. The arms 39L, 39R are substantially identical so that a description of one will suffice for both, and the reference characters for each will be the same except for the suffix “L” for left arm and the suffix “R” for right arm. A crank portion 43L of the arm 39L, located on the opposite of the pivot from a major portion 45L of the arm, is pivotally connected by way of a pin 47L to a rod 49L of a cylinder, generally indicated at 51L. A body 53L of the cylinder 51L is pivotally attached by bolts to a block 55 on the base 41. As may be seen in FIG. 3, extension of the rods 49L, 49R from the bodies 53L, 53R of the cylinders 51L, 51R opens the arms 39L, 39R (shown in phantom), and retraction of rods into the bodies closes the arms. Referring to FIG. 4, the pivot connection of the arm 39L to the base 41 comprises a hinge pin 57L received through a cylindrical sleeve 59L and passing through (along with the sleeve) an opening 61L in the arm 39L located between the crank portion 43L and major portion 45L. The lower end of the pin 57L has a smaller diameter and is threaded to receive a nut 63L which secures the arm 39L to the base 41. The arm 39L is spaced from the base by an annular lower bushing 65L and is sandwiched between the lower bushing and an annular upper bushing 67L. The hinge pin 57L and sleeve 59L are received through both the lower and upper bushings 65L, 67L.

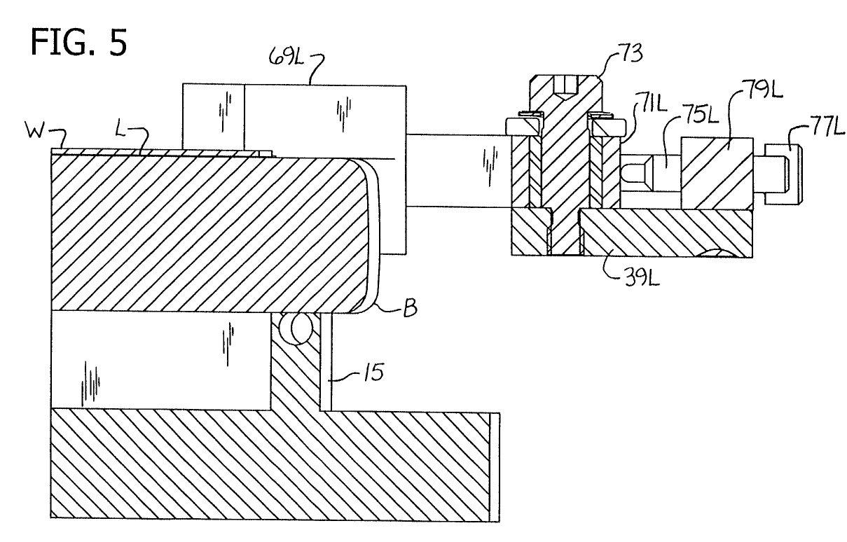

Two locator fingers 69L attached to the arm 39L are engageable with the wafer peripheral edge for use in centering the wafer W on the polishing block B. Preferably, the fingers are made of a plastic which is rigid and has a high degree of chemical purity. Each locator finger 69L is attached to one end of a bracket 71L by a pair of bolts. The other end of the bracket 71L receives a hinge pin 73L threaded into the arm 3 9L at its lower end for pivotally mounting the bracket on the arm (FIG. 5). A pin spring 75L and a shoulder bolt 77L are received through a positioning block 79L mounted on the arm 39L. The pin spring 75L engages the bracket 71L and biases it inwardly away from the arm 39L and toward the polishing block B. The shoulder bolt 77L provides an adjustable barrier limiting the amount by which the bracket 71L can reverse pivot against the bias of the spring 75L.

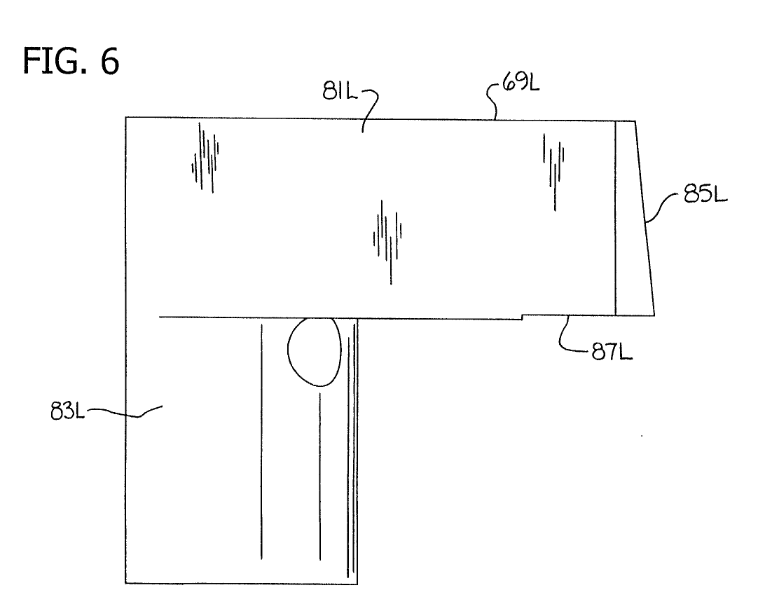

As may be seen in FIG. 6, each locator finger 69L has in side elevation the shape of an “L” turned on its side, and includes a wafer contact portion 81L and a polishing block contact portion 83L. As the arms 39L, 39R are closed by operation of the cylinders 51L, 51R, the block contact portions 81L, 81R of the locator fingers 69L, 69R engage the peripheral edge of the polishing block B to positively locate the locator fingers relative to the polishing block (see FIG. 5). The brackets 71L, 71R pivot to allow the locator fingers 69L, 69R to move back as needed so that all four locator fingers engage the polishing block B. In this way the free ends of the wafer contact portions 81L of the fingers are positioned relative to the polishing block B to center the wafer W on the block. This allows for some imprecision in the placement of the polishing block B in the apparatus 9. The free ends 85L, 85R of the fingers 69L, 69R are beveled for guiding the wafer W to the centered position. In practice, a circle including a radially innermost point on the free end of each finger 69L, 69R has a diameter which is about 1 mm greater than that of the wafer. The underside of the wafer contact portion 81L, 81R of each finger 69L, 69R includes a rabbetted portion 87L so that the underside of the wafer contact portion is spaced above the mounting surface of the polishing block B. The rabbetted portion 87L provides clearance of the finger 69L, 69R from the wax layer L so that the finger does not disturb the layer of wax L on the polishing block.

Referring again to FIG. 1, the wafer pressing mechanism 21 comprises a pneumatic cylinder 91 attached to the frame 19 and extending down from the frame. The rod 92 extending from the cylinder 91 has a bladder fixture (generally indicated at 93) mounted at its lower end including a backing plate 95 and a ring 97. A bladder 99 is secured to the backing plate 95 by the ring 97 defining an air tight chamber between the backing plate and bladder. As an example, the bladder 99 may be a circular sheet of silicone material having a thickness of about ⅛″ (3.2 mm). However, it is to be understood that other suitable materials (e.g., rubber or neoprene) and other configurations and thicknesses may be used without departing from the scope of the present invention. Generally, the material should have a tensile strength which is about 500 to 2,000 psi (340 to 1380 N/cm²). In an undeflected position, the bladder 99 lies substantially flat against the backing plate. The bladder 99 may be selectively extended by delivering pressurized air to the bladder from a source (not shown) of pressurized air. The bladder 99 is shown expanded in FIG. 1.

Having described the structure of the apparatus 9 of the present invention, the process for manufacturing a semiconductor wafer using the apparatus will now be described. Semiconductor material for the wafer may be made in a conventional fashion. In a typical production process, semiconductor material is formed according to the Czochralski method in which highly pure polycrystalline silicon is melted in a crucible. A monocrystalline seed crystal is brought into contact with the melted polycrystalline silicon and then withdrawn so that material from the melt freezes on and around the seed crystal. The seed crystal is drawn up to a desired length to form a generally cylindrical ingot of monocrystalline semiconductor material. The ingot is trimmed to a more precisely cylindrical shape and a flat or notch is formed along its length. Wafers are sliced from the ingot in a suitable manner and then cleaned to remove debris. Preferably slicing by a wire saw is employed to minimize damage to front and back sides of the wafers, although conventional internal diameter saws could also be employed. Subsequent processing of the wafer W is conducted to form at least one highly flat, highly reflective, substantially damage free surface. There are several variations in the processing, including the addition of steps, subsequent to slicing which are well known to those of ordinary skill in the art, and it is to be understood that these variations fall within the scope of the present invention.

Typically the wafers are thinned and planarized following slicing by lapping. Lapping is performed on both sides of the wafers to obtain a more precise thickness, to remove the non-uniform damage left by slicing and to attain parallelism and flatness. If lapping is done in a single step, an identifying laser mark is applied just prior to lapping. In some cases, the laser marks are applied to the back sides of the wafers. The thickness of the wafers following lapping is slightly greater than the final thickness, because the thickness is decreased during subsequent steps such as etching and polishing. Other thinning and/or planarizing procedures may be employed, such as grinding or even double side polishing. Lapping still leaves the front and back sides of the wafers with damage which must be removed. Cleaning after lapping removes particulates on the wafer but damage on the sides remains.

Chemical etching is used after lapping to remove damage. Etchants in routine use typically contain a strong oxidizing agent, such as nitric acid, dichromate, or permanganate, a dissolving agent, such as hydrofluoric acid, which dissolves the oxidation product, and a diluent such as acetic acid. The relative proportion of these acids which produces the smoothest and most uniform etching, however, is one at which the removal rate is still relatively high. To minimize nonuniformity, therefore, the wafers are rotated as they are etched. However, it has been found that the removal rate is not entirely uniform. As a result, a raised ring is left at the peripheral edges of the front and back sides of the wafers. It is envisioned that etching may include plasma assisted etching or other processing steps which remove the same type of damage without departing from the scope of the present invention.

The wafer W is now ready for single side polishing, such as by an automated polishing apparatus shown in co-assigned U.S. Pat. No. 5,605,487. As stated previously, the apparatus 9 of the present invention may be incorporated into the polishing apparatus of the '487 patent. It is to be understood that other polishing apparatus may be used, including those which are not fully automated, without departing from the scope of the present invention. A ceramic polishing block B is cleaned and grasped by the pinchers 31 of the robot 23 for travel to the a wax application station (not shown). A suitable wax is dissolved and applied to a mounting surface of the block as the block is spun about an axis passing through the center of the block and perpendicular to the mounting surface. Wax is preferably applied in a thickness from about 2-15 microns, and most preferably about 8-12 microns. The polishing block B and wax layer L are then grasped once again by the pinchers 31 of the robot 23 and taken to the apparatus 9. The robot places the polishing block on platform 15, which comprises the steam pot 29. The steam pot heats the polishing block at atmospheric pressure to promote evaporation of solvent used to liquify the wax.

After depositing the polishing block B on the platform 15 of the apparatus 9, the robot 23 acquires a semiconductor wafer W. The wafer is held by the vacuum gripper 33 of the robot 23 for travel to the apparatus 9. The robot 23 moves the wafer to a position over the mounting surface of the polishing block. Previously, the wafer centering device 17 will have be activated to close the arms 39L, 39R about the polishing block B on the platform 15. As a result, the locator fingers 69L, 69R register against the peripheral edge of the polishing block B by engagement of the wafer contact portions 83L, 83R with the peripheral edge, and position the free ends 85L, 85R about the mounting surface of the polishing block in a four point retaining/centering system. The free ends 85L, 85R are concentric with the polishing block. The robot 23 is programmed to center the wafer W over the polishing block B. The wafer is then lowered to a closely spaced position from the wax layer L on the mounting surface of the polishing block (e.g., about 0.5 mm from the top of the wax). This position is schematically illustrated in FIG. 7A. The illustrations of FIGS. 7A-7D are not proportional and spacing is exaggerated so that it is visually perceptible. The wafer W is substantially undeflected as held by the vacuum gripper 33. Certainly, the peripheral edges of the wafer are not bent upwardly.

The vacuum gripper 33 releases the wafer W so that the wafer free falls the short distance onto the wax layer L, as shown in FIG. 7B. If the wafer W is off-center or tries to move off-center as it falls, the locator fingers 69L, 69R guide the wafer to a centered position on the polishing block B. More particularly, one or more of the locator fingers 69L, 69R on the side to which the wafer is offset from center engage the peripheral edge of the wafer engage the wafer and push it toward a centered position. The peripheral edge of the wafer W engages the beveled free end(s) 85L, 85R of the locator finger(s) 69L, 69R, sliding the wafer toward a centered position before the wafer contacts the wax layer L. In this way, the position of the wafer is achieved before the wafer contacts the wax layer so that there is virtually no lateral shifting of the wax which could produce undesirable layer thickness variations.

The bladder 99 is expanded by admitting pressurized air between the bladder and backing plate 95. The pneumatic cylinder 91 is activated to extend the rod 92, bringing the center of the bladder 99 into engagement with the center of the wafer W as shown in FIG. 7C. As the bladder 99 continues to move down, the bladder is deformed to gradually engages more of the wafer, moving from the center toward the peripheral edge of the wafer. A pressure regulating valve (not shown) is operable to keep the pressure within the bladder 99 relatively constant. For example the pressure may be maintained between 5 and 20 psi (3 and 14 N/cm²). The cylinders 51L, 51R of the centering device 17 are extended to open the arms 39L, 39R, moving the locator fingers 69L, 69R away from the wafer W as the bladder 99 continues to be pressed down against the wafer. As shown in FIG. 7D, the bladder 99 has not been fully moved down and does not contact the entire front face of the wafer. It will be understood that this gradual contact from the center of the wafer acts to push air out from the wax layer L as the wafer is pushed down into the wax. It has been found that the removal of air is sufficient so that it is unnecessary to mount the wafer at ambient pressures below atmospheric.

After the bladder 99 has been fully pressed against the wafer W, the bladder is deflated, and withdrawn upward by the cylinder 91. The robot 23 moves in and grasps the polishing block B with the pinchers 31. The wafer and polishing block unit U is taken to a polisher. However, prior to that the wafer and polishing block unit U may be annealed to relieve stresses in the wafer W which are present after the mounting process. If the steam pot 29 is used for the wax annealing function, it is set so that the wax is preferably heated to about 50° C. to 150° C., more preferably to about 80° C. to 95° C., and most preferably to about 85° C. The temperature of the steam pot 29 is preferably about 95° C. The heating preferably occurs for a period of between 5 and 300 seconds, more preferably between 10 and 90 seconds, still more preferably between 45 and 60 seconds, and most preferably for about 50 seconds. The wax is preferably maintained at about 85° C. for at least about 40 seconds of the total heating period. Heating in this range causes the wax to soften to the extent that the stress in the wafer W caused by the deformation described hereinabove upon mounting of the wafer to the polishing block B can be relieved by micro-motion of the wafer relative to the polishing block. The stress relief occurs without loss of a bond of the wafer to the polishing block. Wax annealing may be carried out at a different station from where the wafer is mounted on the polishing block. Other suitable reheating processes and temperature ranges may be employed without departing from the scope of the present invention. Moreover, it is not necessary to anneal the wax to fall within the scope of the present invention.

After re-heating is completed to relieve stress in the wafer W, the wafer and polishing block unit U are taken to a polisher (not shown). A suitable polishing treatment is disclosed in aforementioned U.S. Pat. No. 5,605,487. The front side of the wafer W is first rough polished at a relatively high rate of material removal, and then finished polished to form a highly reflective, damage free surface. The wafer and polishing block unit U are held by a polishing arm of a rough polisher against a rotating polishing pad. A slurry is applied to the pad which contains a chemically active agent and small particles for mechanical material removal. The rough polishing slurry preferably comprises a sodium hydroxide stabilized colloidal silica solution such as those commercially available from E. I. du Pont de Nemours & Company, Nalco Chemical Company (Naperville, Ill.) and Cabot Corporation (Tuscolo, Ill.). During delivery of the slurry, the semiconductor wafer W is preferably pressed against the rough polishing pad at a pressure in the range of 4-10 psi (more preferably 6-8 psi). The finish polishing slurry preferably comprises an ammonia stabilized colloidal solution such as those commercially available from Nalco Chemical Company and Fujimi Incorporated. The polishing arm of the finish polisher presses the wafer W against the pad with less force that the rough polisher. A softer polishing pad is also employed.

After polishing the wafer and block unit U, the wafer W is separated (“demounted”) from the block. It has been found that the release of the wafer from the block does not cause the edge ring to reappear at substantially its full original height on the front side of the wafer. In addition, raised bumps on the front surface, caused by laser marks on the back surface, which were present after conventional processing are substantially eliminated. As a result, a the front surface of the wafer has a greater freedom from surface features which can detrimentally affect oxide layer uniformity and wafer surface flatness. The wafer is cleaned in a suitable manner and packaged for delivery to a device manufacturer.

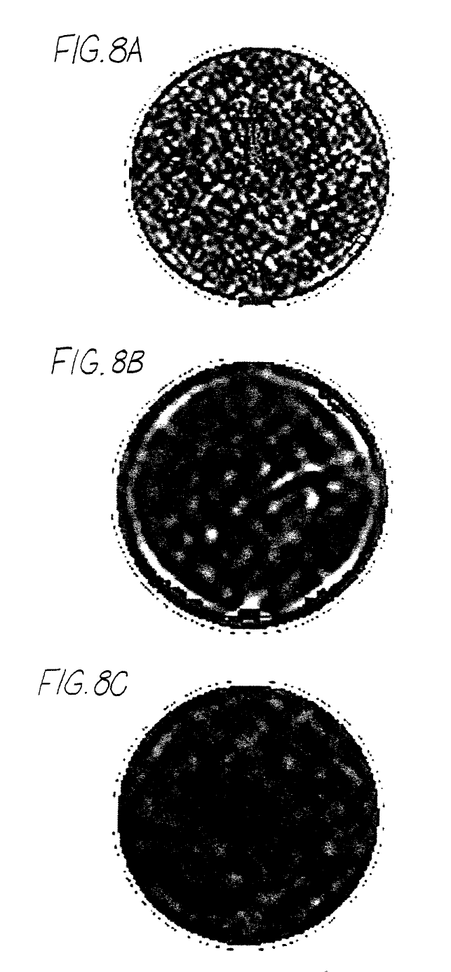

FIGS. 8A and 8B are magic mirror images of wafers processed according to convention cold wax mounting (FIG. 8A) and conventional low pressure mounting (FIG. 8B). A wafer W processed according to the present invention is shown in FIG. 8C. It may readily be seen in the absence of sharp color contrasts in FIG. 8C as compared with 8A and 8B, that a wafer with fewer surface features is produced. In particular, there is no edge ring, such as may particularly be seen in FIG. 8B and no localized bump indicating the presence of laser marking. Indeed, in comparisons with existing local site (or SFQR) flatness data produced by the assignee, the process and apparatus of the present invention yields results which are comparable to or better than existing processes and apparatus.

In view of the above, it will be seen that the several objects of the invention are achieved and other advantageous results obtained. The wafer W produced with the apparatus 9 and according to the process of the present invention has a nanotopography with a markedly reduced number of front side surface features which negatively impact device manufacture. The absence of a substantial edge ring or front side bumps caused by laser marks permits the oxide layer thickness to remain substantially uniform even when CMP processes are employed in device manufacture. The apparatus and process can be carried out quickly and at atmospheric pressure so that throughput is increased.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A process of forming a semiconductor wafer which inhibits the formation of surface features on a polished front side of the wafer, the process comprising the steps of:
slicing a wafer from an ingot of semiconductor material;
removing damage from at least one side of the wafer;
forming a layer of wax on a mounting surface of the polishing block;
mounting the semiconductor wafer on the mounting surface of the polishing block, said step of mounting including the steps of holding the wafer in an undeflected position, dropping the undeflected wafer so that a backside of the wafer contacts the layer of wax, and inflating a bladder to press the wafer into the wax and remove air from between the wafer and the polishing block in the wax;
polishing the front side of the wafer as mounted on the polishing block by holding the polishing block and rubbing the front side of the wafer against a polishing pad in the presence of a polishing slurry;
removing the polished wafer from the polishing block; and
cleaning the wafer.

2. A process of forming a semiconductor wafer as set forth in claim 1 wherein said step of mounting the wafer further includes the step, subsequent to said step of dropping the wafer, of centering the wafer on the polishing block.

3. A process of forming a semiconductor wafer as set forth in claim 2 wherein said step of centering the wafer includes providing a locator engageable with the wafer for centering the wafer on the polishing block.

4. A process of forming a semiconductor wafer as set forth in claim 3 further comprising the step of removing the locators from a position in which the locators are engageable with the wafer to center the wafer subsequent to inflating the bladder to press the wafer into the wax.

5. A process of forming a semiconductor wafer as set forth in claim 1 wherein said step of mounting the wafer further comprises moving the bladder downwardly.

6. A process of forming a semiconductor wafer as set forth in claim 1 further comprising heating the wax bonding the wafer to the polishing block to a temperature and for a time selected to soften the wax and permit the wafer to move relative to the polishing block toward the relaxed configuration without breaking the bond of the wafer to the polishing block thereby to relieve stress in the wafer.

7. A process of forming a semiconductor wafer as set forth in claim 1 wherein said step of mounting the wafer is performed at atmospheric pressure.

8. Apparatus for wax mounting a semiconductor wafer on a polishing block in preparation for polishing a front side of the wafer, the apparatus comprising:
a platform for holding the polishing block with a mounting surface of the polishing block having a layer of wax thereon facing upward;
a wafer centering device movable relative to the platform between closed and open positions, in the closed position the wafer centering device being disposed relative to the platform for engagement with the wafer to center the wafer on the mounting surface of the polishing block;
a wafer pressing mechanism engageable with the front face of the wafer for pressing the wafer into the wax on the mounting surface of the polishing block.

9. Apparatus as set forth in claim 8 wherein the wafer centering device comprises locator fingers adapted to be located relative to a peripheral edge of the polishing block and having a distal surface disposed for engagement with the wafer to center the wafer on the polishing block.

10. Apparatus as set forth in claim 9 wherein the locator fingers are shaped for engaging the peripheral edge of the polishing block for locating the distal surfaces relative to the polishing block for centering the wafer thereon.

11. Apparatus as set forth in claim 10 wherein the distal surface is angled for guiding the wafer upon engagement with the distal surface toward a centered position on the block.

12. Apparatus as set forth in claim 10 wherein the wafer centering device comprises arms mounting the locator fingers for movement relative to the platform between the closed and open positions.

13. Apparatus as set forth in claim 12 wherein the locator fingers are mounted on the arms for movement relative to the arms.

14. Apparatus as set forth in claim 13 wherein the wafer centering device further comprises springs for biasing the locator fingers outwardly from the arms.

15. Apparatus as set forth in claim 14 wherein there are two of the arms, each being mounted for pivoting motion between the open and closed positions.

16. Apparatus as set forth in claim 8 wherein the wafer pressing mechanism comprises a bladder expandable by inflation into engagement with the wafer on the mounting surface of the polishing block for pressing the wafer into the wax on the mounting surface, the bladder being disposed for engaging the wafer near a center of the wafer front face and gradually increasing the area of engagement toward a peripheral edge of the wafer as the bladder is inflated.

17. Apparatus as set forth in claim 16 further comprising a robot for delivering the wafer to the platform and polishing block thereon and for removing the polishing block and mounted wafer from the platform, the robot being adapted to drop the wafer in an undeflected condition onto the wax on the mounting surface of the polishing block.

18. Apparatus as set forth in claim 8 wherein the platform includes a polishing block heater for heating the polishing block and wax on the mounting surface of the polishing block.
